(19) United States
(12) Patent Application Publication
(10) Pub. No.: US 2016/0150360 A1
(43) Pub. Date: May 26, 2016

(54) CANOPY TRACKING DEVICE FOR SKYDIVING EQUIPMENT

(71) Applicant: Brendan Pope, Des Plaines, IL (US)

(72) Inventor: Brendan Pope, Des Plaines, IL (US)

(73) Assignee: Fearless Technology, LLC, Ottawa, IL (US)

(21) Appl. No.: 14/808,487

(22) Filed: Jul. 24, 2015

Related U.S. Application Data
(60) Provisional application No. 62/083,209, filed on Nov. 22, 2014.

(51) Int. Cl. H04W 4/02; B64D 17/00

(52) U.S. Cl. CPC H04W 4/02; B64D 17/00

(57) ABSTRACT

A canopy tracking device for a skydiving system kit is provided. The canopy tracking device includes a tracking device mounted to or embedded in a riser. The tracking device remains powered off until a cut-away system of the skydiving kit is activated. Once activated the device powers on and collects GPS data regarding location of the canopy. The tracking device communicates this GPS data via a cellular network to a user-accessible server.

### CROSS REFERENCE TO RELATED APPLICATIONS

This application claims the benefit of U.S. Provisional Patent Application Ser. No. 62/083,209, filed Nov. 22, 2014, titled “GPS tracking device for retrieving parachutes/canopies in the event of a cut-away or malfunction,” the teachings and disclosure of which is incorporated by reference herein in its entirety herein.

### FIELD OF THE INVENTION

This invention generally relates to skydiving equipment, and more particularly to tracking devices associated with a main canopy of a skydiving system.

### BACKGROUND OF THE INVENTION

As is readily understood in the art, a contemporary skydiving system or kit includes a harness, a deployable main canopy, i.e. parachute, connected to the harness, and a deployable reserve canopy, also connected to the harness. In the event the main canopy fails to open or opens but is unserviceable, a user can deploy the reserve canopy as an alternative. To effectuate a deployment of the reserve canopy where the main canopy has already been deployed, however, requires that the main canopy first be disconnected from the user's harness. Otherwise, deployment of the reserve canopy will cause the reserve canopy to become entangled or otherwise engage the already-deployed main canopy.

To disconnect the main canopy in the event of such an emergency situation, what is known as a cut-away system is utilized. More specifically, the main canopy is connected to the harness by way of strap-like elements referred to as risers. One end of the riser is connected to the harness. The other end of the riser has cordage extending therefrom to the main canopy. The aforementioned cut-away system provides a way to quickly disconnect the risers from the harness. In mid-flight, this causes the user to disconnect from the main-canopy and continue to fall.

While such a system has proven itself in the field, it is not without its drawbacks. Notably, once the main canopy is “cut away” from the user's harness, it can drift a great distance away from the landing zone of the user. Main canopies are typically expensive components of a skydiving system, and as such, if a cut away canopy becomes lost the user will need to replace this expensive component.

There have been attempts to address this problem by utilizing main canopy tracking devices. Such systems employ a transmitting device which allows a user to track the main canopy. Such systems, however, have proven to be cumbersome and undesirable by the skydiving enthusiast. Indeed, such systems operate by emitting a constant radio transmission or “ping” which can be tracked by a user using specialized antennas and equipment.

One downside of such systems is the necessity of such a specialized antenna. Further, the range of such systems is relatively short, thus requiring a significant amount of searching by a user to situate the antenna within a range where the antenna can detect the transmission of the tracking device. Further, the electronics of many such systems are “always-on” configurations in that they are powered on at all times. This requires frequent charging or replacement of the batteries thereof which serve as the power source of such systems. In such a configuration, there is a risk of drainage of the battery without constant monitoring of the remaining life thereof. Further, where a charging configuration is utilized, there is a risk a user will forget to charge the system. These and other disadvantages have led to a need in the art for a parachute tracking and recover system which requires minimal maintenance, and allows for long distance tracking, at minimal expense and effort by a user.

The invention provides such a system. These and other advantages of the invention, as well as additional inventive features, will be apparent from the description of the invention provided herein.

### BRIEF SUMMARY OF THE INVENTION

In one aspect, the embodiments of the present invention provide a tracking device in a skydiving system. The skydiving system includes a deployable main canopy and a cut-away system for selectively disconnecting the main canopy from a user harness of the skydiving system. The tracking devise comprises a communications module, a power source for selectively applying electrical power to the communications module, and a switch arrangement. The switch arrangement is interposed between the communications module and the power source. The switch arrangement is configured such that when the cut-away system is activated to disconnect the main canopy from the user harness, the switch arrangement completes a circuit between the communications module and power source such that electrical power is applied to the communications module.

The communications module comprises a GPS receiver, cellular transmitter, and a processor in communication with each of the GPS receiver and cellular transmitter. The processor is configured to receive a set of GPS coordinates from the GPS receiver and transmit the set of core GPS coordinates via the cellular transmitter to a cellular network.

In one embodiment, the communications module and power source are housed within a common housing, and the switch arrangement is arranged in a housing separate from the housing which commonly houses the power source and communications module.

In another embodiment, the communications module, power source, and switch arrangement are housed within a common housing. The housing contains a passage way through the housing. The passage way is arranged and configured to receive a cut-away cord of the cut-away system. A portion of the switch arrangement is disposed within the passage way. The portion of the switch arrangement which is disposed within the passage way is an end of a rocker arm of a switch.

In another embodiment, the switch arrangement includes a reed switch and a magnet. Upon actuation of the cut-away system to disconnect the main canopy from the harness, the magnet is biased by a spring into proximity with the reed switch.

In another embodiment, the switch arrangement includes a pair of rocker arms positioned within a passage way of a housing of the switch arrangement. The passage way is configured to receive a cut-away cord of the cut-away system. The pair of rocker arms are arranged such that their respective ends contact the cut-away cord when present within the passage way. The respective ends of the rocker arms contact each other when the cut-away cord is not present within the passage way.

In yet another embodiment, the switch arrangement is contained within a housing having a passage way. The switch arrangement further comprises a lanyard having a free end and a clasp at an end thereof opposite the free end. The lanyard is received within the passage way and wherein the clasp is configured to connect to the user harness.

In another aspect, embodiments of the present invention provide a riser for a skydiving system. The riser includes an embedded tracking device. The tracking device is configured to emit a signal upon actuation of a cut-away system of the skydiving system. The signal includes a set of GPS coordinates.

The tracking device also includes a communications module, a power source, and a switch arrangement configured to detect an actuation of the cut-away system. The communications module comprises a GPS receiver, a cellular transmitter, and a processor in communication with each of the GPS receiver and cellular transmitter. The processor is configured to receive a set of GPS coordinates from the GPS receiver and transmit the set of GPS coordinates via the cellular transmitter to a cellular network.

The switch arrangement is configured to receive one of a cut-away cord of the cut-away system or a lanyard. The switch arrangement is also configured to close a circuit upon removal of the cut-away cord or the lanyard from the switch arrangement. In one embodiment, the switch arrangement includes at least one rocker arm which is arranged such that it contacts the cut-away cord or the lanyard.

In yet another aspect, embodiments of the present invention provide a method of tracking a main canopy of a skydiving system. The method includes providing a riser having an embedded tracking device. The method also includes configuring the embedded tracking device to emit a signal including GPS coordinates upon an actuation of a cut-away system of the skydiving system.

The method can also include receiving GPS coordinates via a cellular network in a server. The method can also include providing user access to the server such that a user may obtain the GPS coordinates. The method may also include providing user access via a mobile application. The method may also include providing user access to the server via a desktop application.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic representation of a skydiving system utilizing a cut-away system;

FIGS. 2-3 are side views of a riser of the skydiving system of FIG. 1 incorporating a tracking device according to the teachings of the present invention;

FIG. 4 is a schematic flowchart of the communication scheme of a tracking device according to the teachings of the present invention;

FIG. 5 is a perspective view of one embodiment of a tracking device according to the teachings of the present invention;

FIG. 6 is a schematic wiring diagram of the tracking device of the present invention;

FIGS. 7-8 are perspective cross sections of a switching device of the tracking device of FIG. 5;

FIG. 9 is a cross section of a communication module of the tracking device of FIG. 5;

FIG. 10 is a plan view of another embodiment of a tracking device according to the teachings of the present invention;

FIG. 11 is a plan view of another embodiment of a tracking device according to the teachings of the present invention;

FIGS. 12-13 are plan views of another embodiment of a switching device of a tracking device according to the teachings of the present invention;

FIGS. 14-15 are plan views of another embodiment of a switching device of a tracking device according to the teachings of the present invention;

FIG. 16 is a perspective view of another embodiment of a tracking device according to the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

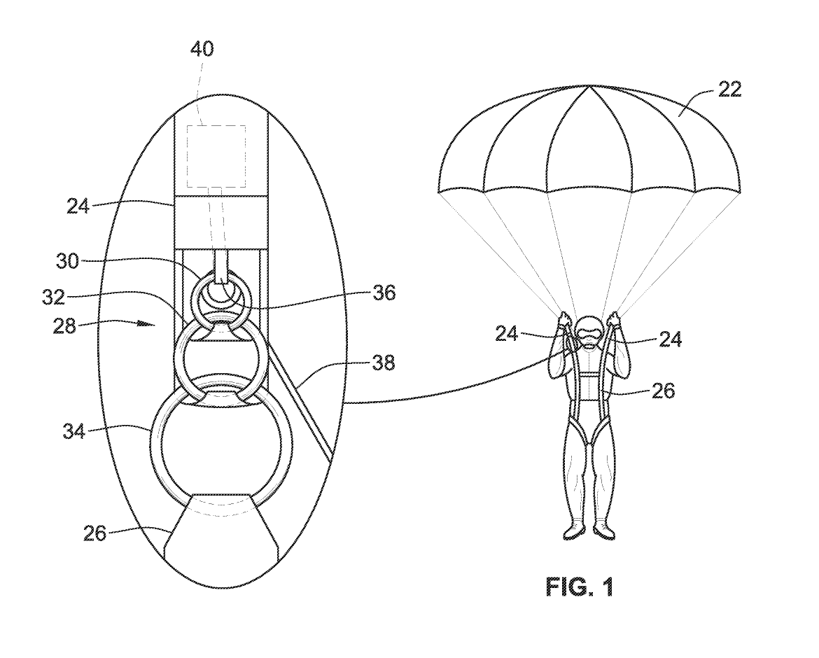

Turning now to the drawings, FIGS. 1-16 illustrate various embodiments and features of a tracking device for a skydiving system according to the teachings of the instant invention. This system overcomes the various disadvantages of prior designs described above by providing a reliable and efficient way to track the location of a main canopy which has been cut-way. Embodiments of the invention provide a tracking device which collects and sends GPS coordinate data via a cellular network to a user-accessible server. Such a configuration advantageously allows for the GPS coordinate data to be retrieved remotely using a computer or mobile device. As a result, a hand held antenna is not required to track or listen for a “ping” of the tracking device, unlike prior designs.

Further, embodiments of the invention provide a tracking device which is not in an “always-on” configuration in that it employs a novel and inventive switching arrangement which cooperates with a cut-away system of a skydiving kit such that actuation of the cut-away system causes the tracking device to power on. Otherwise, the tracking device remains dormant. This conserves battery power, and also avoids the need to charge the unit or frequently inspect it to ensure it has adequate electrical power to achieve its tracking functionality, also unlike prior designs.

Turning now to FIG. 1, an exemplary embodiment of a skydiving system employing a tracking device according to the teachings of the present invention is illustrated. The skydiving system includes a deployable main canopy 22 which is connected via risers 24 to a harness 26. A cut-away system 28 is utilized between each riser 24 and harness 26 such that the risers 24 and their connected main canopy 22 may be rapidly disconnected from harness 26 in an emergency situation during free fall. In the exemplary embodiment, the cut-away system 28 includes a 3-ring configuration which is typically utilized in such cut-away systems. As we readily understood by those of skill in the art, the 3-ring system includes a first ring 30 which is looped through a second ring 32. The first and second rings 30, 32 are connected to riser 24. A third ring 34 is connected to harness 26. Second ring 32 is looped through third ring 34 as shown. A cut-away loop 36 is also formed on riser 24 and cooperates with the first ring 30. Upon actuation of cut-away system 28, and more specifically, the pulling downward of cut-away cord 38, cut-away loop 36 is removed from contact from first ring 30. This causes first ring 30 to pass back through second ring 32, and second ring 32 to pass back through third ring 34 ultimately to disconnect riser 24 from harness 26.

As will be explained in greater detail below, the tracking device 40 of the instant invention is embedded in riser 24 such that it is operable to detect the actuation of cut-away system 28. Upon this actuation, tracking device 40 powers on and begins its tracking functionality. By “embedded” it is meant that tracking device 40 forms an integral part of riser 24. This may be achieved by adhering tracking device 40 directly to an exterior of riser 24 using an adhesive, hook and pile tape, or any other mechanical means. Further, this embedded configuration may also be achieved by sewing tracking device 40 into riser 24 via a covering fabric or riser material. Such a sewn in configuration provides additional protection from the elements and wear and tear.

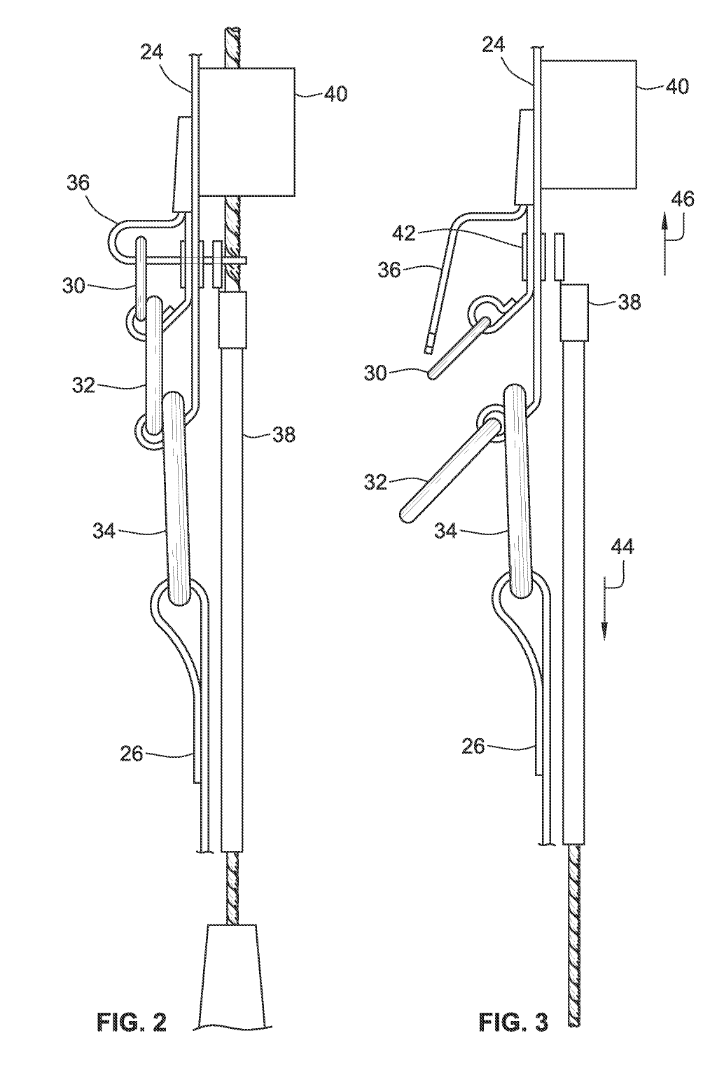

Turning now to FIGS. 2 and 3, FIG. 2 illustrates the cut-away system prior to its actuation. As can be seen therein, a portion of cut-away cord 38 passes through tracking device 40. With reference to FIG. 3, the same illustrates cut-away system after its actuation. As can be seen therein cut-away cord 38 has been pulled downwardly in direction 44. This causes a disconnection between riser 24 and harness 26 as discussed above. As a result, each riser 24 and the main canopy 22 (see FIG. 1) connected to these risers 24 moves upwardly in direction 46. As can also be seen in FIG. 3, cut-away cord 38 no longer passes through tracking device 40. The absence of cut-away cord 38 within tracking device 40 is detected by a switching arrangement thereof which causes tracking device 40 to power on. As will be understood from the following, although tracking device 40 is illustrated in operation with a cut-away cord 38 of tracking device 28, tracking device 40 may also operate with a separate lanyard which has a free end passing through tracking device 40 and a hook which connects to harness 26. Upon actuation of cut-away system 28, harness 26 will move away from risers 24 as shown in FIG. 3 which will in turn draw the aforementioned lanyard out of tracking device 40 to achieve the tracking functionality described herein.

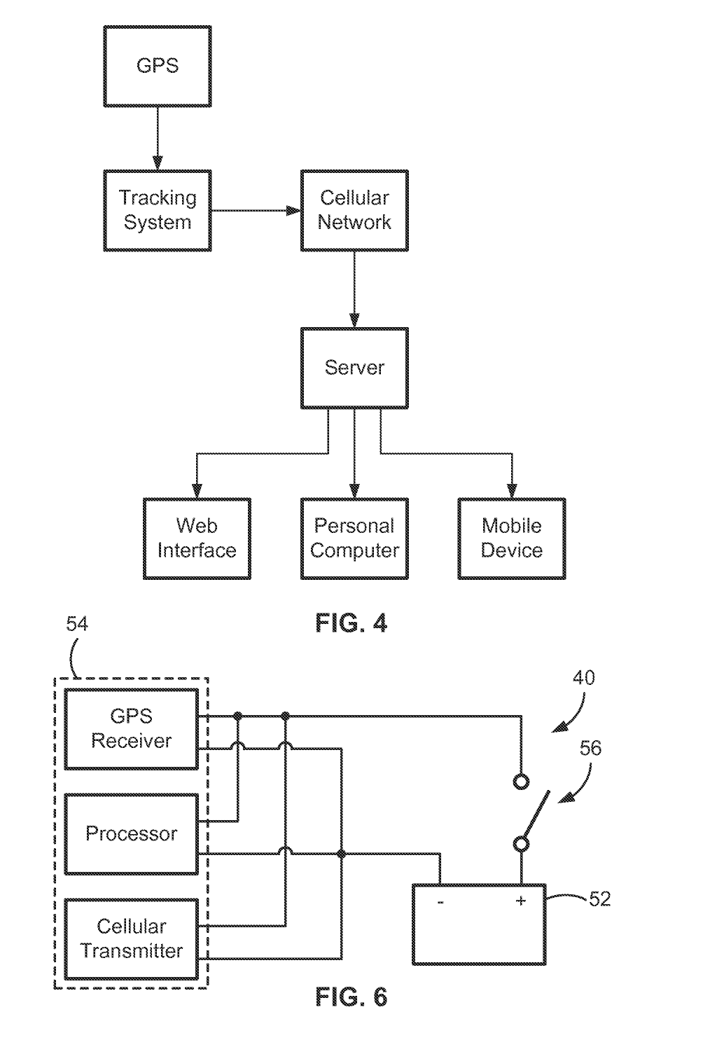

Turning now to FIG. 4, the same illustrates the schematic communications protocol of tracking device 40. More specifically, tracking device is configured to receive GPS (Global Positioning Satellite) data. Tracking device 40 is also configured to transmit this received GPS data via a cellular network to a user accessible server. The GPS data corresponds to the physical location of the main canopy after it has been cut away and has returned to the ground. This GPS data may be raw in format, or may be converted into another convenient format such as latitude and longitude coordinates, or MGRS (military grid reference system) coordinates, for example.

This data is then made available via the server to users to subsequently track and locate their lost main canopy. For example, a user could access the server by way of a mobile device using a mobile application. As another example, a user could access the server by way of their own personal computer and dedicated software. As yet another example, a user could access the server by way of a web interface via a personal computer or mobile device. Such a configuration advantageously allows a user to readily determine where their main canopy has landed without the need to resort to the use of handheld antennas or other specialized tracking devices. The data may be simply presented as the GPS data in a suitable format, or alternatively, a user may be provided with a waypoint or “pin” on a graphical map indicating the position of the main canopy.

Turning now to FIG. 5, a physical embodiment of tracking device 40 is shown therein. This tracking device 40 includes a first housing 58 which contains a switching arrangement 52 and a communications module 54. The system also includes a switch arrangement 56 contained in a second housing 60. Switch arrangement 56 is electrically connected by way of cable 64 to power source 52 and communications module 54. Second housing 60 also includes a passageway 62 for passage therethrough of a terminal end of cut-away cable 38. Cut-away cable 38 is movable within passage 62 in direction 44 upon actuation of cut-away system 28 (see FIG. 1). Once cut-away cable 38 is completely removed from passage way 62, switching arrangement 56 closes a circuit formed between power source 52 and communications module 54. This powers on communication module 54 and allows it to collect GPS data and subsequently transmit the same via a cellular network to a user accessible server as described above relative to FIG. 4.

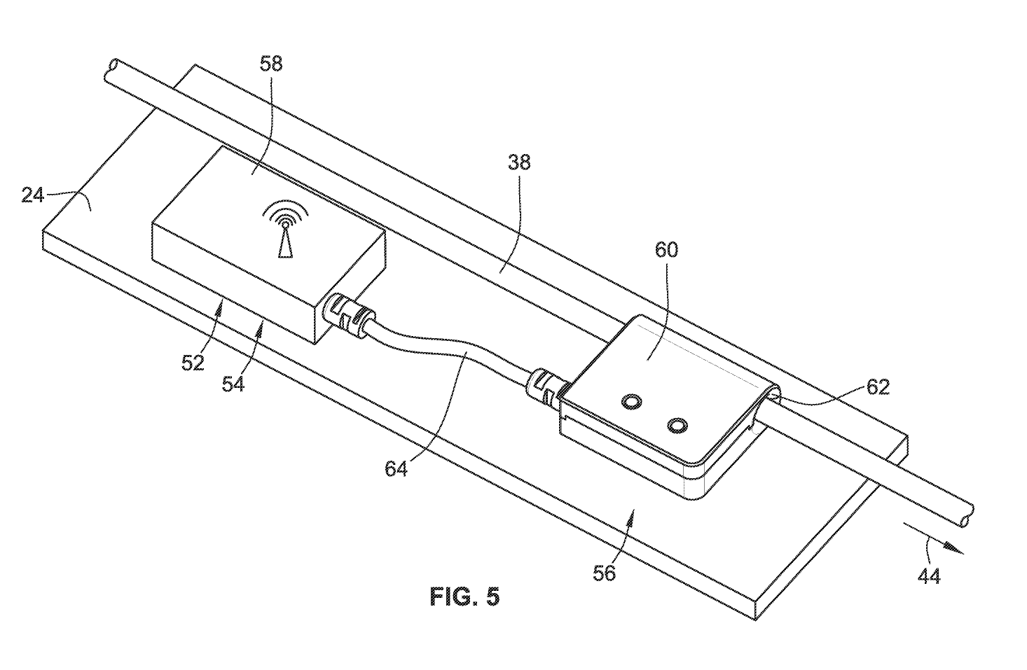

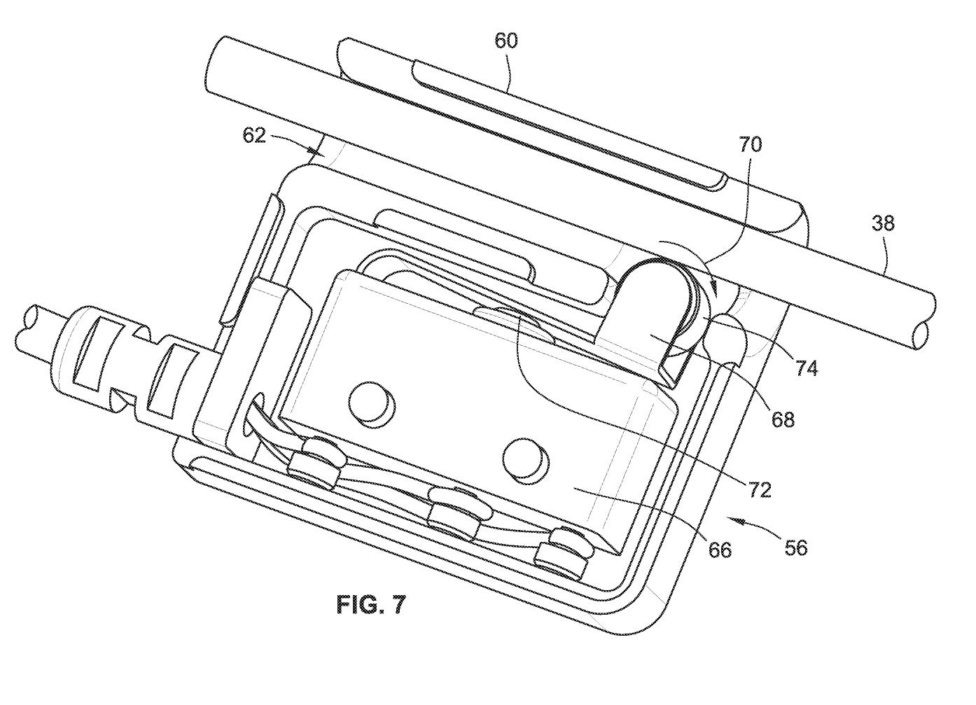

Turning now to FIG. 6, a general wiring schematic of tracking device 40 is illustrated. As can be seen therein, switch arrangement 56 is functionally arranged to open and close a circuit between power source 52 and communications module 54. It should be understood that the illustration of FIG. 6 is schematic and exemplary in nature. The particular arrangement and connection of power source 52, communications module 54, and switch arrangement 56 may vary. However, it will be noted that in each case, switch arrangement 56 is operable to selectively allow for electrical power to be applied to communications module 54.

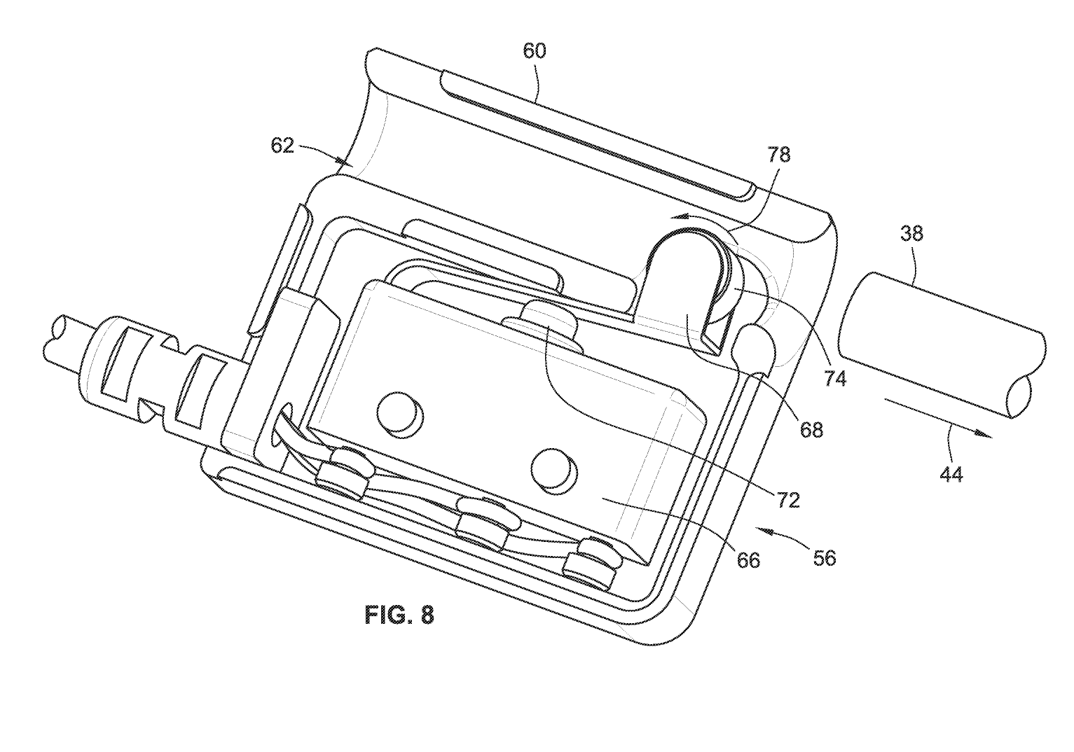

Turning now to FIG. 7, the interior of second housing 60 is illustrated. As can be seen therein, switch arrangement 56 includes a switch 66. Switch 66 includes a rocker arm 68. An end portion of rocker arm 68 is disposed within passage 62 through second housing 60 such that the presence of cut-away cable 38 within passage 62 will depress rocker arm 68 and generally rotate the same in direction 70 as shown. This causes rocker arm 68 to depress a depressible button 72 of switch 66. Such an arrangement causes an open circuit between power source 52 and communications module 54 as described above. In other words, power is not supplied to communications module 54 when cut-away cable 38 is present within passage way 62.

However, upon removal of cut-away cable 38 in direction 44 from passage way 62, rocker arm 68 moves generally in direction 78 as shown in FIG. 8. As a result, depressible button 72 is no longer depressed. This closes a circuit between power source 52 and communications module 54. As a result, electrical power is supplied to communications module 54 so that it can achieve its tracking functionality as described herein.

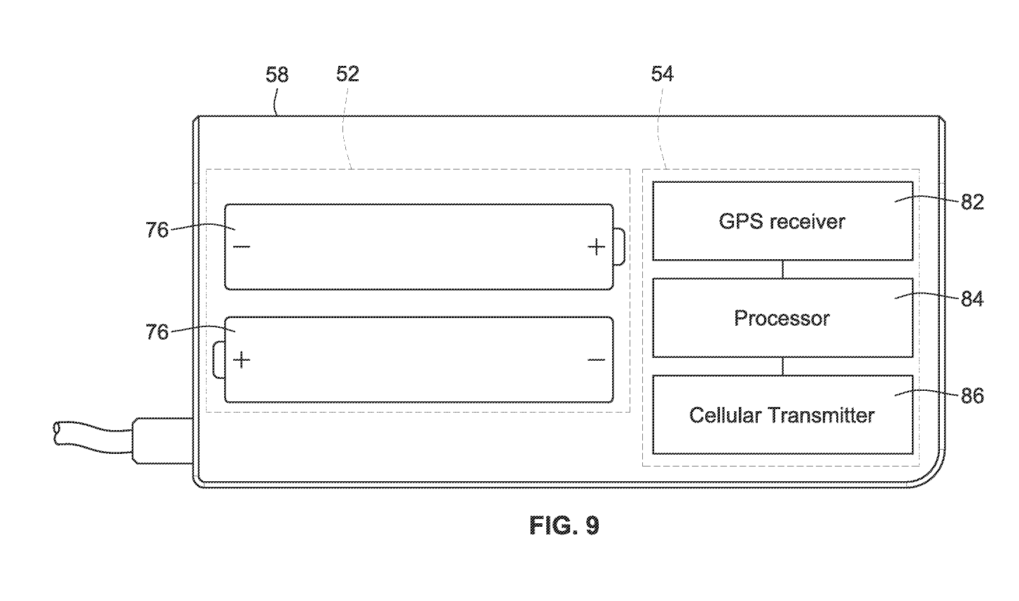

Turning now to FIG. 9, the same illustrates the interior of first housing 58. As can be seen therein power source 52 and communications module are schematically shown contained within first housing 58. In the illustrated embodiment, power source 52 is formed by a pair of batteries 76. The particular shape and configuration of battery 76 illustrated is for exemplary purposes only. Any type of battery-type power source may be utilized for power source 52. As such, the illustration in FIG. 9 should be taken by way of example only.

Communications module 54 is also shown schematically including a GPS receiver 82, a processor 84, and a cellular transmitter 86. GPS receiver 82 and cellular transmitter 86 are each connected to processor 84. The term “processor” as used herein includes all of the necessary software, firmware, and hardware necessary to gather GPS data received by GPS receiver, and cause the transmission of the same by way of cellular transmitter 86. Although not shown, communications module 54 may also be sealed or encapsulated to protect the same from the ingress of moisture and other contaminants using any convenient electronics sealing methodology. Indeed, first housing 58 may employ gaskets or rtv seals, or alternatively, communications module 54 may be entirely encapsulated as mentioned previously.

As discussed above, cellular transmitter 86 transmits the GPS data collected by GPS receiver 82. This may be effectuated on a scheduled basis to conserve the power supply available from power source 52. Indeed, the GPS data may for example be transmitted every 15 minutes for the first 6 hours, and then hourly thereafter. Any transmission schedule may be readily customized via the configuration of processor 54. As discussed above, once received on the server side, the GPS data may be accessed via a mobile device using a mobile application. Rather than employ a mobile application, the GPS data may be sent by way of a SMS message to a user's mobile device. Also as discussed above, the GPS data may be accessed using a web application or a software program on a computing device. In all cases, all that is required is that a user establish an account with a provider which links the particular device ID of their tracking device 40 with their profile.

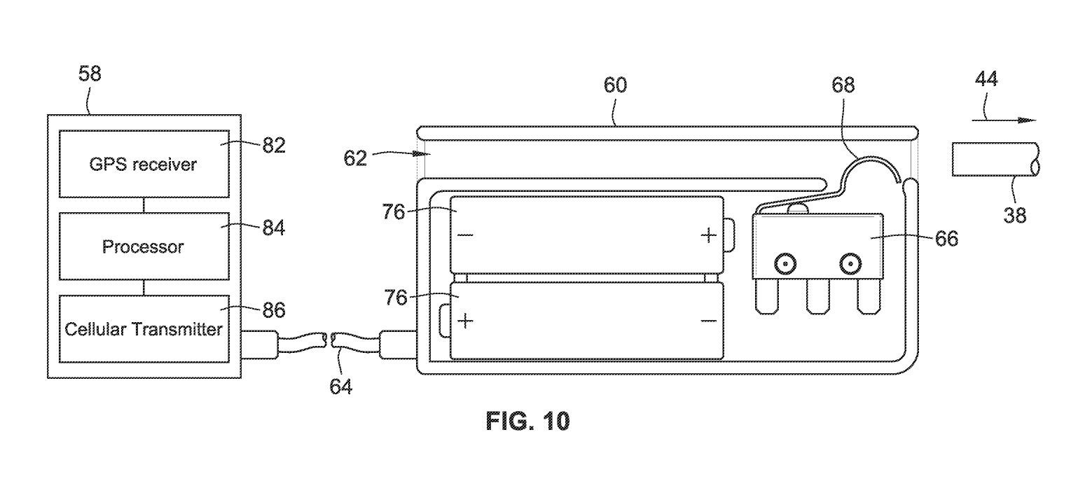

Turning now to FIG. 10, an alternative embodiment of tracking device 40 is illustrated. In this embodiment, first housing 60 incorporates power source 52 as well as switching arrangement 56. More specifically, battery 76 and switch 66 are contained within second housing 60. It will also be noted that in this view, a simplified rocker arm 68 is employed. This rocker arm does not include a rolling contact element 74 as is shown with respect to rocker arm 68 illustrated in FIGS. 7 and 8. Such a rolling contact element 74 advantageously allows for a smooth transition of cut-away cord 38 from passage way 62. However, such a rolling contact element 74 is not required and may be omitted in favor of the more simplified rocker arm 68 illustrated in FIG. 10.

Still referring to FIG. 10, in this embodiment, first housing 58 houses only the communications module 54. Cable 64 connects first and second housings 58, 60 such that power may be selectively applied from battery 76 to the communications module 54 which includes the GPS receiver 82, processor 84, and cellular transmitter 86 shown in FIG. 10.

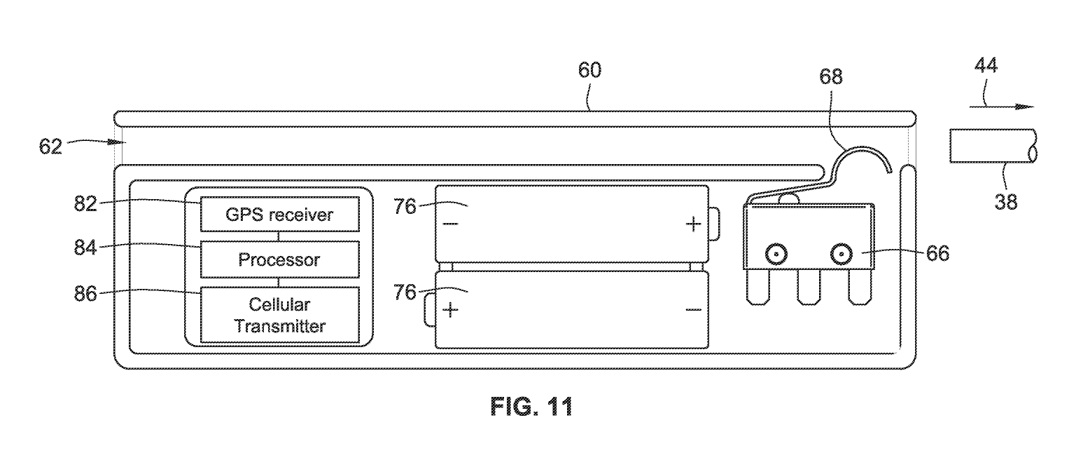

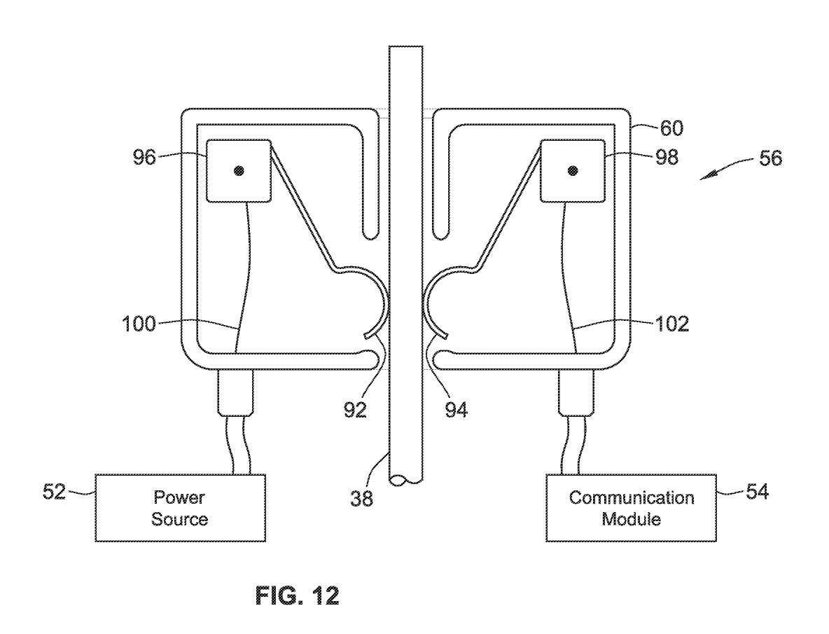

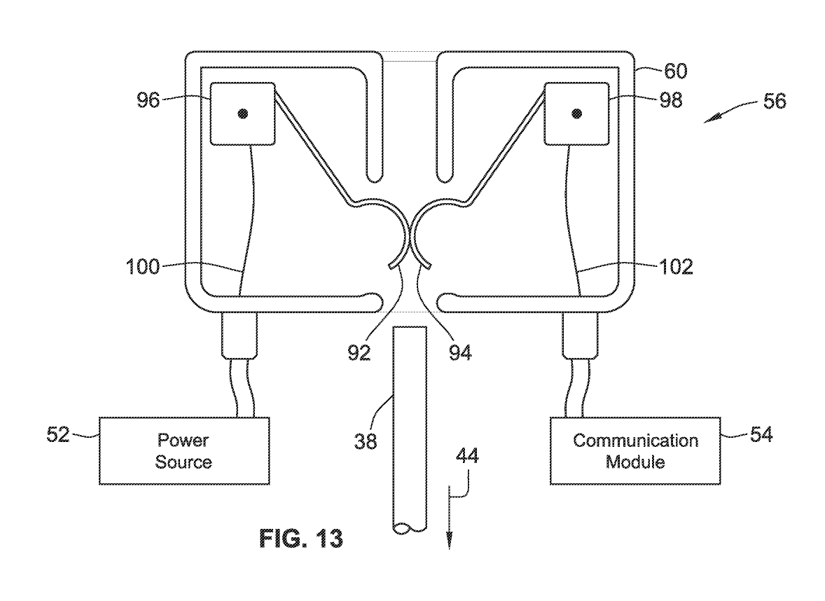

Turning now to FIG. 11, yet another embodiment is shown of tracking device 40. In this case, second housing 60 houses each of power source 52, communications module 54, and switching arrangement 60. More specifically, this single second housing 60 contains switch 66, battery 76, GPS receiver 82, processor 84, and cellular transmitter 86. While being generally larger than the embodiments described above, this embodiment advantageously provides a simplified single housing unit. Turning now to FIG. 12, an alternative embodiment of switch arrangement 56 is illustrated. In this embodiment, a pair of rocker arms 92, 94 are separated by the presence of cut-away cord 38. Rocker arm 92 is connected to a termination point 96. Wiring 100 extends from this termination point 96 to power source 52 as shown. Likewise, rocker arm 94 is connected to a termination point 98. Wiring 102 extends from termination point 98 to communications module 54. Rocker arms 92, 94 and termination points 96, 98 are all electrically conducted. As a result, the separation of rocker arms 92, 94 by the presence of cut-away cord 38 prevents electrical power to pass from power source 52 to communications module 54. Turning now to FIG. 13, the same illustrates the embodiment of FIG. 12 wherein cut-away cord 38 has been drawn away or out of second housing 60 in direction 44. As a result, rocker arms 92, 94 make contact with one another and close a circuit between power source 52 and communications module 54. Communications module then undergoes its data collection and transmission functionality as discussed above.

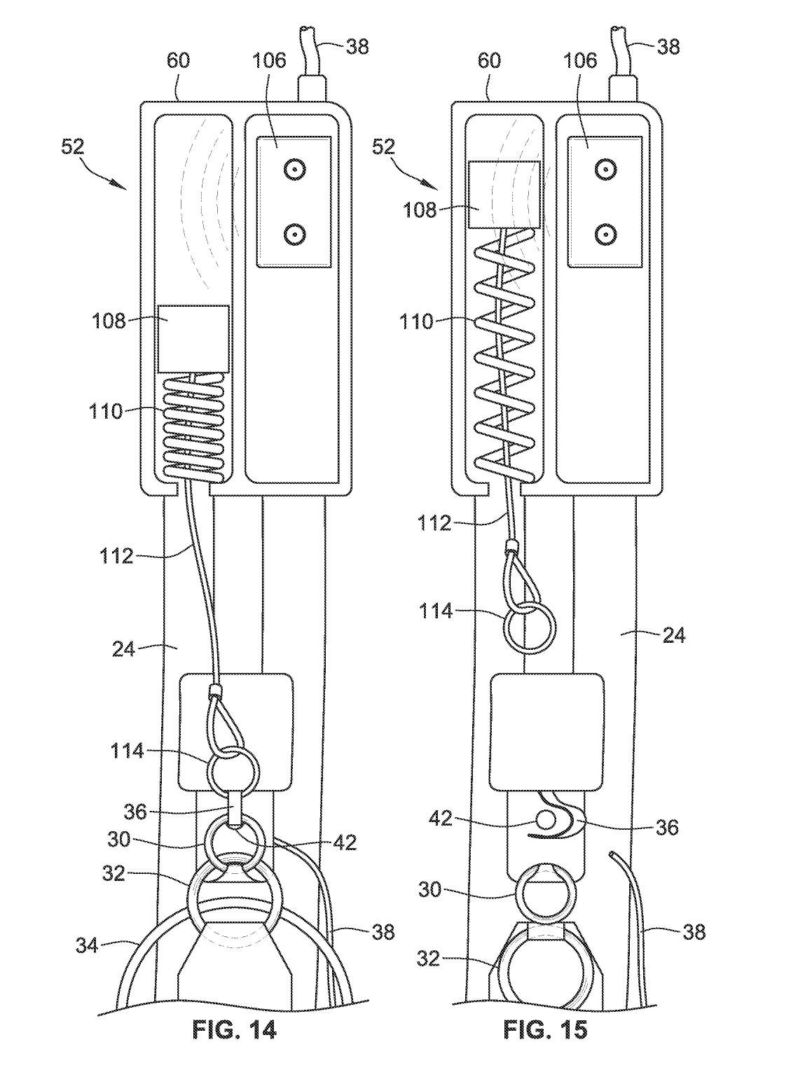

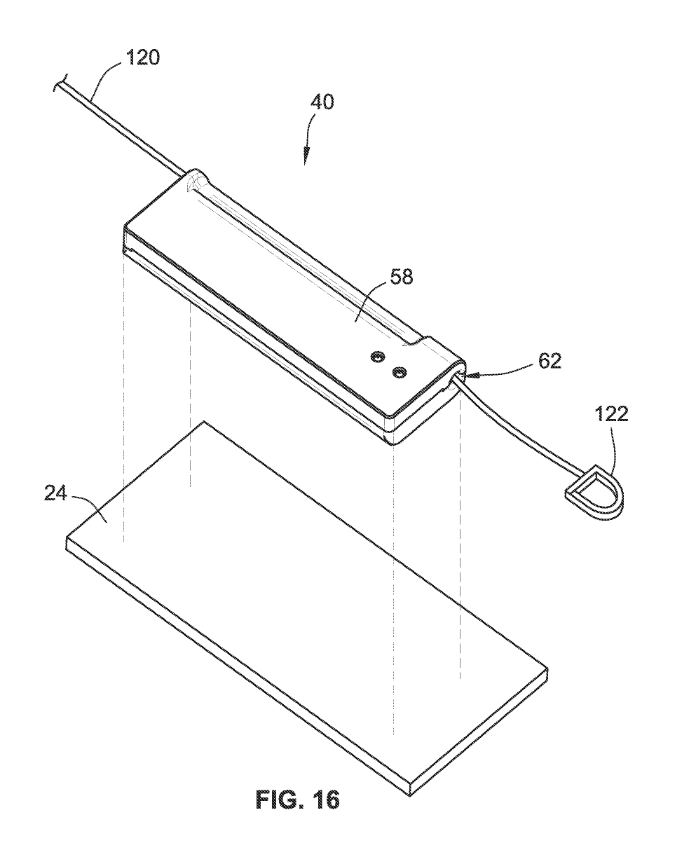

Turning now to FIGS. 14 and 15, the same illustrate yet another embodiment of a switch arrangement 52. In this embodiment, the same does not utilize cut-away cord 38. Rather, the same employs a reed switch 106 which detects the presence or absence of a magnet 108. Prior to actuation of the cut-away system, magnet 108 is pulled out of the detection range of reed switch 106. This is achieved by way of a lanyard 112 which is fastened to magnet 108. Lanyard 112 in turn is fastened to cut-away loop 36 as shown. Upon actuation of the cut-away system as described above, cut-away loop 36 is freed from its connected position such that a spring 110 positioned within second housing 60 biases magnet 108 upward and into proximity of reed switch 106 as shown in FIG. 15. This closes a circuit formed between power source 52 and communications module 64. Indeed, switching arrangement 52 shown in FIGS. 14 and 15 is connected by way of cable 64 to power source 52 and communications module 54 in the same manner as described above. Additionally, a hall effect sensor may also be utilized in place of reed switch 106, which is also operable to detect the presence of mange 108.

In the various embodiments described above, it is contemplated that tracking device 40 is embedded in a riser 24 such a user may simply replace an existing riser with a riser having an embedded tracking device as described herein. In other words, a riser 24 having a tracking device 40 may be provided as a stand-alone product for eady implementation. However, tracking device 40 may be supplied without a riser for ready incorporation into an existing riser without the replacement thereof. Indeed, and turning now to FIG. 16, yet another embodiment of a tracking device 40 is illustrated. In this embodiment, a single housing 58 is shown which houses a power source 52, communications module 54, and switch arrangement 56 as described above. For example, switch arrangement 56 may be a simple rocker arm switch as described above, or a dual rocker arm switch as described above. Rather than utilize the cut-away cord 38 of the system, a lanyard 120 having a free end is passed through passage way 62 of housing 58. This lanyard includes a clasp 122 at an end thereof. Clasp 122 may be fastened to any convenient location of harness 26 (see FIG. 1) such that when the cut-away system 28 is actuated and riser 24 moves relative to harness 26, lanyard 120 will be drawn out of housing 58 to thereafter close a circuit between power source 52 and communications module 54.

In another implementation, the switch arrangement 56 may be embodied simply as a pull tab which interrupts electrical connection between power source 52 and its associated electrical contacts. Such a pull tab may extend outwardly from the housing described above and be fastened, e.g. adhered, to user harness 26. Upon separation of riser 24 from user harness 26, the pull tab is drawn out of housing and no longer interrupts the electrical connection of power source 52 and its associated electrical contact.

It will be recognized that such non-cut away cord based configurations readily allow for a tracking device to be employed on an existing riser 24. Indeed, housing 58 may include adhesive, Velcro, or other fastening means to fasten housing 58 to an exterior of riser 24. Thereafter, lanyard 120 may be fastened using clasp 122 to any convenient portion of harness 26, or in the case of the pull-tab configuration, the pull tab may be fastened to any convenient portion of harness 26. This advantageously allows a user to incorporate the tracking methodology described herein with an existing set of risers 24. Further, such a system may be employed in a skydiving kit which does not utilize a cut-away system having a cut-away cord. In other words, all that is required is that the device be mounted to an existing riser, and fasten lanyard or pull-tab to a convenient location along a harness.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A tracking device in a skydiving system, the skydiving system including a deployable main canopy and a cut-away system for selectively disconnecting the main canopy from a user harness of the skydiving system, the tracking device comprising:
a communications module;
a power source for selectively applying electrical power to the communications module; and
a switch arrangement interposed between the communications module and the power source and configured such that when the cut-away system is activated to disconnect the main canopy from the user harness, the switch arrangement completes a circuit between the communications module and power source such that electrical power is applied to the communications module.

2. The tracking device of claim 1, wherein the communications module comprises a GPS receiver.

3. The tracking device of claim 2, wherein the communications module further comprises a cellular transmitter.

4. The tracking device of claim 3, wherein the communications module further comprises a processor in communication with each of the GPS receiver and cellular transmitter, the processor configured to receive a set of GPS coordinates from the GPS receiver and transmit the set of GPS coordinates via the cellular transmitter to a cellular network.

5. The tracking device of claim 1, wherein the communications module and power source are housed within a common housing, and the switch arrangement is arranged in a housing separate from the housing which commonly houses the power source and communications module.

6. The tracking device of claim 1, wherein the communications module, power source, and switch arrangement are housed within a common housing, the housing containing a passageway through the housing, the passageway arranged and configured to receive a cut-away cord of the cut-away system, wherein a portion of the switch arrangement is disposed within the passageway.

7. The tracking device of claim 6, wherein the portion of the switch arrangement disposed within the passageway is an end of a rocker arm of a switch.

8. The tracking device of claim 1, wherein the switch arrangement includes a reed switch and a magnet, wherein upon actuation of the cut-away system to disconnect the main canopy from the harness, the magnet is biased by a spring into proximity with the reed switch.

9. The tracking device of claim 1, wherein the switch arrangement includes a pair of rocker arms positioned within a passageway of a housing of the switch arrangement, the passageway configured to receive a cut-away cord of the cut-away system, wherein the pair of rocker arms are arranged such that their respective ends contact the cut-way cord when present within the passageway, and such that their respective ends contact each other when the cut-way cord is not present within the passageway.

10. The tracking device of claim 1, wherein the switch arrangement is contained within a housing having a passageway, and wherein the switch arrangement further comprises a lanyard having a free end and a clasp at an end thereof opposite the free end, wherein the lanyard is received within the passageway and wherein the clasp is configured to connect to the user harness.

11. A riser for a skydiving system, the riser comprising an embedded tracking device, the tracking device configured to emit a signal upon actuation of a cut-away system of the skydiving system, wherein the signal includes a set of GPS coordinates.

12. The riser of claim 11, wherein the tracking device includes a communications module, a power source, and a switch arrangement configured to detect an actuation of the cut-away system.

13. The riser of claim 12, wherein the communications module comprises a GPS receiver, a cellular transmitter, and a processor in communication with each of the GPS receiver and cellular transmitter, the processor configured to receive a set of GPS coordinates from the GPS receiver and transmit the set of GPS coordinates via the cellular transmitter to a cellular network.

14. The riser of claim 12, wherein the switch arrangement is configured to receive one of a cut-away cord of the cut-away system or a lanyard, and is configured to close a circuit upon removal of the cut-away cord or the lanyard from the switch arrangement.

15. The riser of claim 14, wherein the switch arrangement includes at least one rocker arm which is arranged such that it contacts the cutaway cord or the lanyard.

16. A method of tracking a main canopy of a skydiving system, the method comprising:
providing a riser having an embedded tracking device; and
configuring the embedded tracking device to emit a signal including GPS coordinates upon an actuation of a cut-away system of the skydiving system.

17. The method of claim 16, further comprising receiving the GPS coordinates via a cellular network in a server.

18. The method of claim 17, further comprising providing user access to the server such that a user may obtain the GPS coordinates.

19. The method of claim 18, wherein the step of providing includes providing user access to the server via a mobile application.

20. The method of claim 18, wherein the step of providing includes providing access to the server via a desktop application.
